(19) United States
(12) Patent Application Publication
(10) Pub. No.: US 2012/0317538 A1
(43) Pub. Date: Dec. 13, 2012

(54) Apparatus for Intermediating Network Operators and Developers

(76) Inventors: Calin Curescu, Solna (SE); Ayodele Damola, Solna (SE); Johan Hjelm, Tokyo (JP); Kenta Yasukawa, Kawasaki (JP)

(21) Appl. No.: 13/578,930

(22) PCT Filed: Feb. 19, 2010
(86) PCT No.: PCT/JP2010/053013

§ 371 Date: Aug. 14, 2012

(51) Int. Cl. G06F 9/44

(52) U.S. Cl. 717/101

(57) ABSTRACT

An apparatus for intermediating a plurality of network operators and one or more developers is provided. The apparatus includes an obtaining unit for obtaining a requirement about a computer program required by each network operator; an integration unit for integrating mutually-related requirements among the obtained requirements into one requirement; a generation unit for generating information about the necessity for development of a computer program implementing the integrated requirement; and a presentation unit for presenting the one or more developers with the integrated requirement and the information about the necessity.

### TECHNICAL FIELD

The present invention relates to an apparatus for intermediating a plurality of network operators and one or more developers.

### BACKGROUND

Many telecom operators and internet service providers are deploying gateways such as DSL modems, O/E converters, PPPoE terminators in their networks to interface with the users' home networks. The traditional function of the gateway is to manage the protocol conversion for devices which are not able to access the network without mediation by the gateway.

Those gateways are now getting to include software execution environment such as OSGi framework that is a dynamic module system for Java. OSGi framework makes it possible to add/remove software modules on it dynamically without restarting Java virtual machine. Such a software module is called a bundle in OSGi terminology. By combining a remote management protocol, OSGi framework is capable of being remotely managed and dynamically deploying new software modules on demand.

By utilizing such a software execution environment, it is possible for a network operator to run software on a gateway which discovers devices in a personal network and exposes control API for those devices so that the network operator can access and control the devices for the user. That means that, by leveraging managed gateways, network operators can offer various kinds of caretaking services which are achieved by monitoring and controlling devices in the personal network, e.g. WiFi access point auto configuration service, home automation and energy management for a home. When the operators try to offer such services, controlling and monitoring programs for wide range of devices are required since a personal network can include wide range of devices which may use different set of protocols. Some devices support standard protocols which can be used for remote control, such as UPnP. However, there are significant amount of devices which need to use proprietary protocols to control and configure. For example, for remotely configuring a Wifi access point which does not support UPnP, but only supports Web GUI, the gateway needs to implement a set of commands which are based on invoking specific HTTP URLs.

For a single network operator, it is not realistic to implement such protocol specific communication software or device specific control program for every device in the personal networks. Such kind of computer program is called device specific software (DSS). Although one solution would be asking third party to develop DSS, it is costly. If multiple network operators form a federation, creates specifications for DSS together and orders third party to make the DSS, the cost for each operator might be reduced by splitting it. According to such an idea for federated market place, US2008103795 introduces federated market place for advertisement. However, making such a federation creates more issues such as: making an agreement and specifications between multiple network operators require a lot of cost and effort; and each network operator needs to expose the requirements to other network operators, that is, network operators in the federation become able to guess what the other network operators are going to deliver to the users.

Therefore, it is desired to provide a technique in which the developers can determine the necessity and requirements for a computer program required by the network operators while each network operator conceals requirements for the computer program.

### SUMMARY

According to an aspect of the invention, an apparatus for intermediating a plurality of network operators and one or more developers is provided. The apparatus includes an obtaining unit for obtaining a requirement about a computer program required by each network operator, an integration unit for integrating mutually-related requirements among the obtained requirements into one requirement, a generation unit for generating information about the necessity for development of a computer program implementing the integrated requirement, and a presentation unit for presenting the one or more developers with the integrated requirement and the information about the necessity.

Further features of the present invention will become apparent from the following description of exemplary embodiments with reference to the attached drawings.

### BRIEF DESCRIPTION OF THE DRAWINGS

FIG. 1 illustrates an exemplary environment including an FBS 100.

FIG. 2 illustrates an exemplary block diagram of the FBS 100.

FIG. 3 illustrates exemplary operations of the FBS 100.

FIG. 4 illustrates an exemplary template API list 400.

FIG. 5 illustrates an exemplary service description 500.

FIG. 6 illustrates an exemplary service description list 600.

FIG. 7 illustrates an exemplary required DSS list 700.

FIG. 8 illustrates an exemplary adaptation program 800.

### DETAILED DESCRIPTION

Embodiments of the present invention will now be described with reference to the attached drawings. Each embodiment described below will be helpful in understanding a variety of concepts from the generic to the more specific. It should be noted that the technical scope of the present invention is defined by claims, and is not limited by each embodiment described below. In addition, not all combinations of the features described in the embodiments are always indispensable for the present invention.

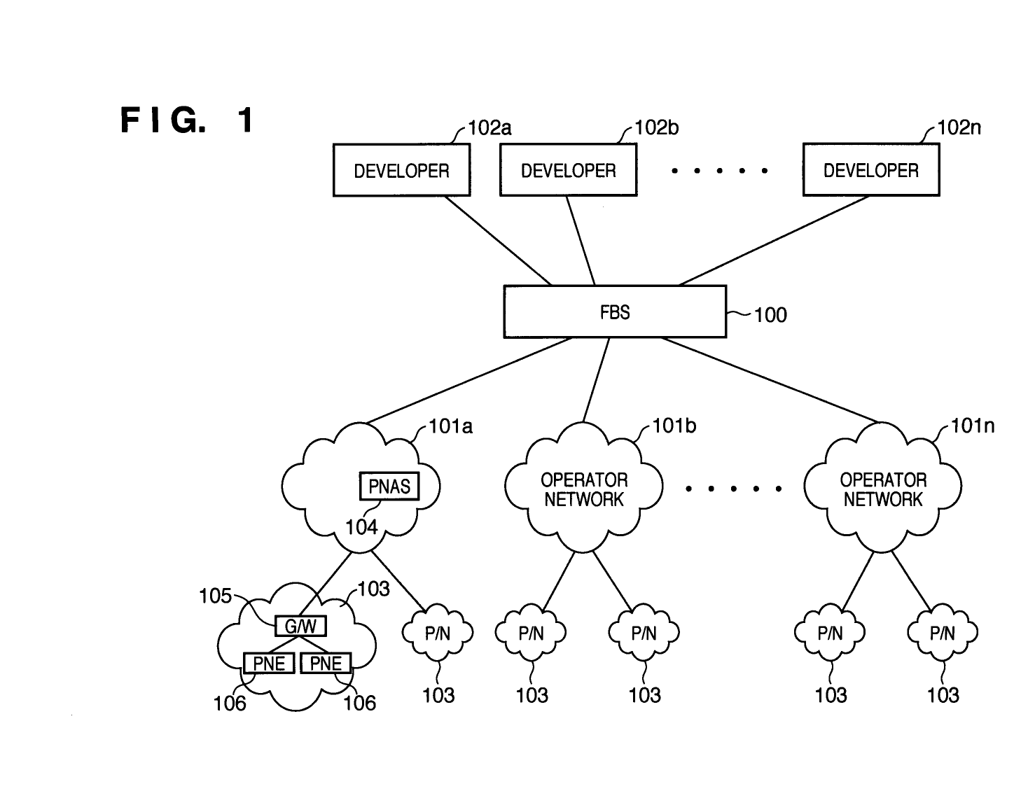

FIG. 1 illustrates an exemplary environment including a Federation Broker Server (FBS) 100 according to an embodiment of the present invention. The FBS 100 is connected with operator networks 101a-101n and developers 102a-102n. The operator network 101a is operated by network operator A, the operator network 101b is operated by network operator B, and so on. That is, the operator networks 101a-101n are operated by different network operators. While there are a number of developers 102a-102n in this embodiment, the present invention also applies when there is only one developer. The operator networks 101a-101n are described as operator network(s) 101 collectively and the developers 102a-102n are described as developer(s) 102 collectively. This embodiment will be described from the viewpoint of the operator network 101a and developer 102a, and this description also applies to the other operator networks 101b-101n and developers 102b-102n.

The operator network 101a is connected with personal networks 103. The personal network 103 is a network in which devices around an owner of the personal network 103 are interconnected with each other to compose a logical network. The devices are exposed to third party service providers and other users' personal networks through wide area network. The personal network 103 is an example of a local network for which the present invention applies. Other examples of the local network are a local area network (LAN), a personal area network (PAN), a car network, and so on. The devices in the personal network 103 are called personal network elements (PNEs) 106. The personal network 103 also comprises a gateway (G/W) 105 though which the PNEs 106 and the operator network 101a communicate with each other. The gateway 105 exposes control API for controlling the PNEs 106.

The operator network 101a comprises a Personal Network Application Server (PNAS) 104. The PNAS is an apparatus used as a central point to retrieve and disseminate context information of the PNEs 106, which includes device presence and capabilities information.

The network operator A offers various services for a user of the personal network 103 by monitoring and controlling the PNEs 106. Examples of the services offered by the network operator A is:
Auto configuration for personal network: It is a difficult job for ordinal people to configure network equipments such as IP routers, Wifi access point and so on. Trouble shooting is also a difficult task for the people. Thus, the network operator A supports such tasks by remotely monitoring and managing configuration.
Auto lighting control: The PNAS 104 monitors the users' location and their activity via PNEs 106 and controls lighting around the users accordingly when, for example, the user is at living room and movie is started, light is dimmed down.

The network operator A has a service description for each service. The service description describes operations for performing a corresponding service. An example of a service description will be described later. The network operator A provides the service descriptions to the FBS 100 in order to ask to create a computer program (DSS) required to perform the operation for the PNEs 106. According to this embodiment, a requirement in a service description is described in the form of API. However, the present invention applies to a requirement described in any form even if the developers 102 can develop a computer program in reference to the requirement.

The FBS 100 intermediates the network operators and the developers 102. The FBS 100 obtains service descriptions from the network operators. It is reasonably assumed that network operators require the same or similar API for devices in the same category since each device only has a specific set of functionalities, and thus lists of required API from network operators tend to overlap. Therefore, the FBS 100 integrates the overlapped APIs into one API. It can easily happen that different network operators have slightly different requirements for each API, such as unit of input and output values, path name. The FBS 100 solves the issue by providing template APIs to the network operators, as described in detail later.

The developer 102a develops computer programs presented by the FBS 100. The developer 102a may be a third party developer, an open source developer, or a non-employed programmer.

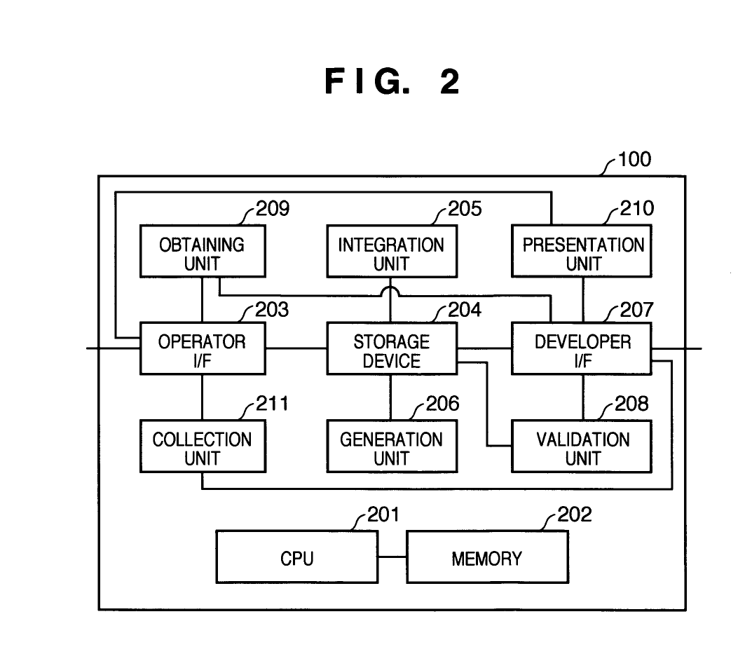

FIG. 2 illustrates an exemplary block diagram of the FBS 100 according to this embodiment. The FBS 100 comprises a CPU 201, a memory 202, an operator I/F 203, a storage device 204, an integration unit 205, a generation unit 206, a developer I/F 207, a validation unit 208, an obtaining unit 209, a presentation unit 210, and a collection unit 211. The CPU 201 controls overall operations of the FBS 100. In FIG. 2, lines from the CPU 201 to each unit are omitted. The memory 202 stores computer programs and data used for operations of the FBS 100. The operator I/F 203 is an interface between the network operators and the FBS 100. The developer I/F 207 is an interface between the developers 102 and the FBS 100. The storage device 204 stores a statistics database, a template API list 400, a service description list 600, a required DSS list 700, and a DSS repository, which are described in detail later. The storage device 204 is implemented by, for example, an HDD. The other units will be described later through the operations of the FBS 100.

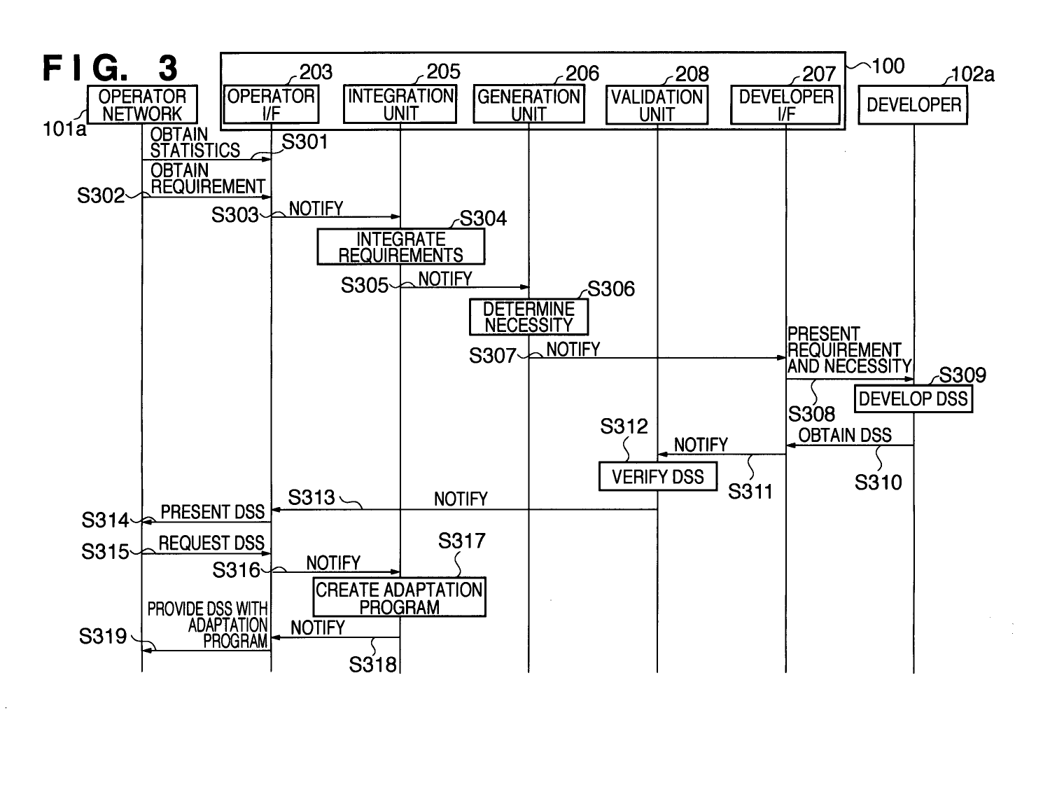

FIG. 3 illustrates exemplary operations of the FBS 100 according to an embodiment according to the present invention. The CPU 201 executes a computer program stored in memory 202 to process these steps.

In step S301, the collection unit 211 collects statistics about the PNEs 106 from the PNASs 104 in the operator networks 101. The collection unit 211 registers the collected statistics in the statistics database in the storage device 204. The statistics may include the number of devices included in the personal networks 103 connected to each operator network 101, for each device type.

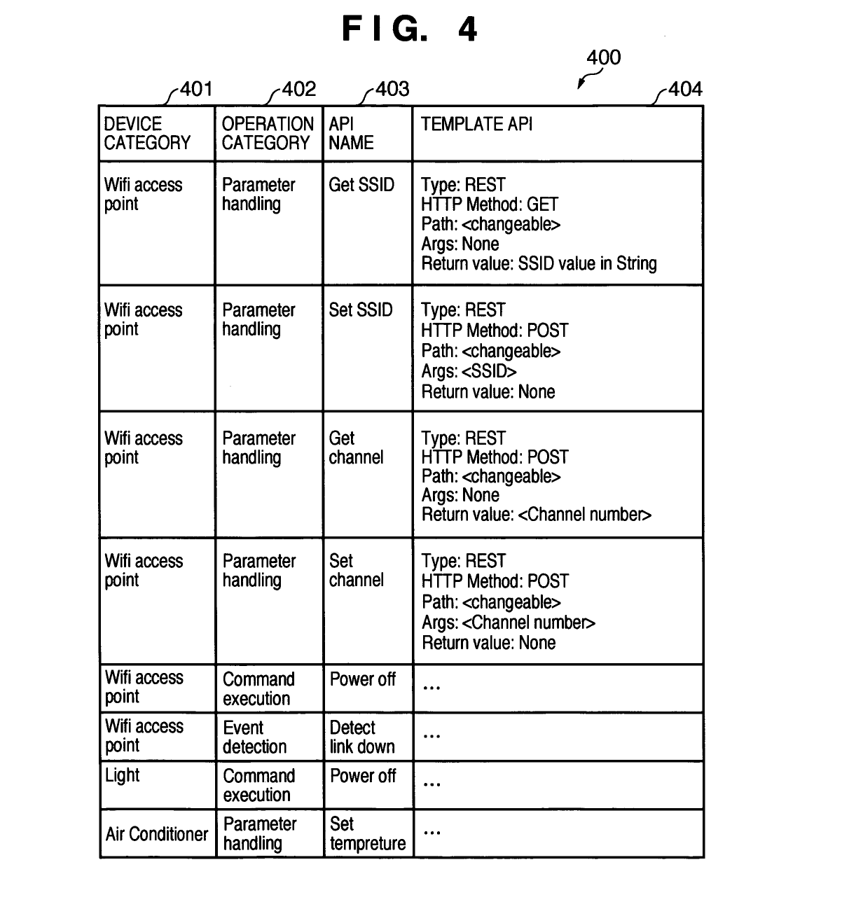

In step S302, the obtaining unit 209 obtains a service description from the network operator A. As described above, the service description includes requirements for DSSs in the form of API. The network operator A prepares a service description prior to step S302, in a format agreed with the owner of the FBS 100. The presenting unit 210 may present template APIs to the network operator A in order to assist the network operator A in the creation of a service description. FIG. 4 illustrates an exemplary template API list 400. Each entry of the list 400 defines a template API for performing a certain operation for a device. The column “DEVICE CATEGORY” 401 describes a category of a device. Devices included in the same category such as Wifi access point tend to have the same or similar operation such as getting SSID. Therefore, the template API list defines a template API for each category, not specific device type. This yields an advantage that the network operator A can perform an operation for the devices in the same category in the same way even if the specific device types of the devices are different. The column “OPERATION CATEGORY” 402 describes a category of the certain operation such as “parameter handling”, which is used for setting or getting a parameter in the device, “command execution”, which is used for executing a command to the device, and “event detection”, which is used for detecting a particular event of the device. The column “API NAME” 403 describes a name for the certain operation. The column “TEMPLATE API” 404 describes details of a template API which is required to achieve the certain operation. For example, the first entry of the list 400 defines a template API for getting SSID of a device whose category is Wifi access point. The template API may include changeable property. For example, the first entry in the list 400, “Path” is changeable. This changeable property is useful for accommodating different requirements between different network operators. As a result, the template API list 400 can cover wide range of use cases from different network operators. The FBS 100 sets a property as changeable when the FBS 100 can change the property after a DSS for the API is developed. According to this embodiment, when the FBS 100 can create a complementary computer program which accommodate a property in the developed DSS in accordance with the requirement from the network operator A, the FBS 100 sets the property as changeable. This yields an advantage that a signal DSS can cover slightly different requirements and thus value of the DSS grows.

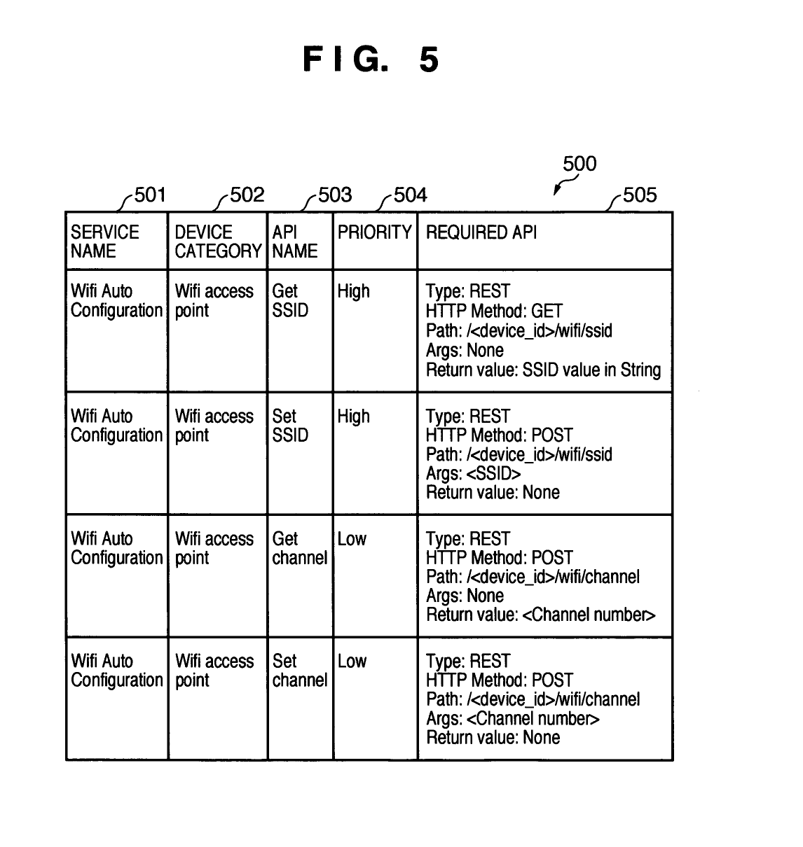

The network operator A may describe a service description using the list 400 of template APIs. FIG. 5 illustrates an exemplary service description 500. Each entry of the service description 500 defines a requirement for performing a certain service. The column “SERVICE NAME” 501 describes a name of the service which the network operator A performs. The columns 502, 503 are the same as the columns 401, 403 in FIG. 4. The column “PRIORITY” 504 describes a priority for the operation. For example, the required API is mandatory for the service, the priority may be set to “High”, whereas the required API is optional for the service, the priority may be set to “Low”. The column “REQUIRED API” describes details of API required for performing the operation. The network operator A selects a template API which meets the requirement of the network operator A and changes the changeable property so as to accommodate the template API to the required API. For example, the network operator A sets the “Path” property in FIG. 5.

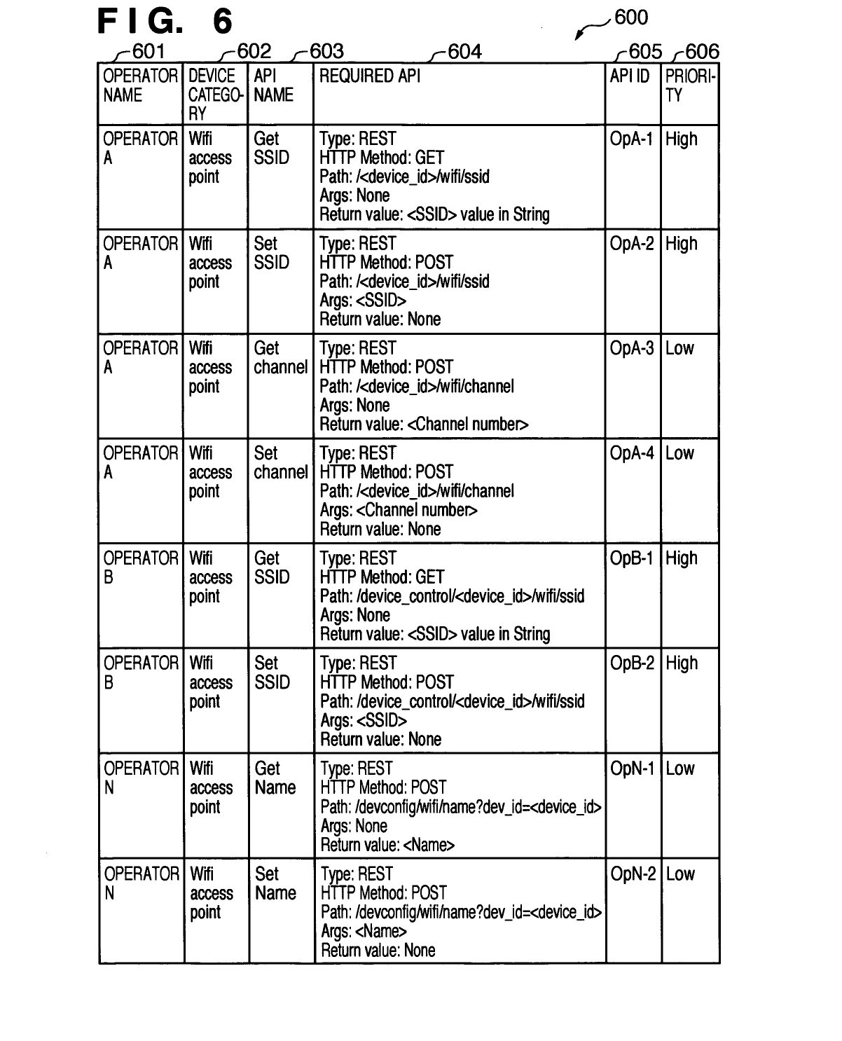

In step S302, the obtaining unit 209 stores the obtained service description in the storage device 204. The service descriptions obtained from the network operators are maintained as a service description list. FIG. 6 illustrates an exemplary service description list 600. Each entry of the list 600 describes a required API obtained from each network operator. The column “OPERATOR NAME” 601 describes a name of network operator from which the required API is obtained. The columns 602-604, 606 are the same in the corresponding columns in FIG. 5. The column “API ID” 605 is ID for identifying the entry of the list 600. “API ID” 605 is used for tracking the relationship between a required API and an integrated API. In step S303, the obtaining unit 209 notifies the integration unit 205 that the service description list 600 is updated.

In step S304, the integration unit 205 integrates the required APIs which are related mutually into one API. According to this embodiment, in order to integrate APIs, the integration unit 205 compares the required API with the template API. When two or more required APIs in the service description list 600 correspond to the same template API, the integration unit 205 determines that these required APIs are related mutually and integrates these required API into one integrated API. For example, both the first and fifth entries in the service description list 600 correspond to the first entry in the template API list 400, and thus the integration unit 205 integrates these required APIs.

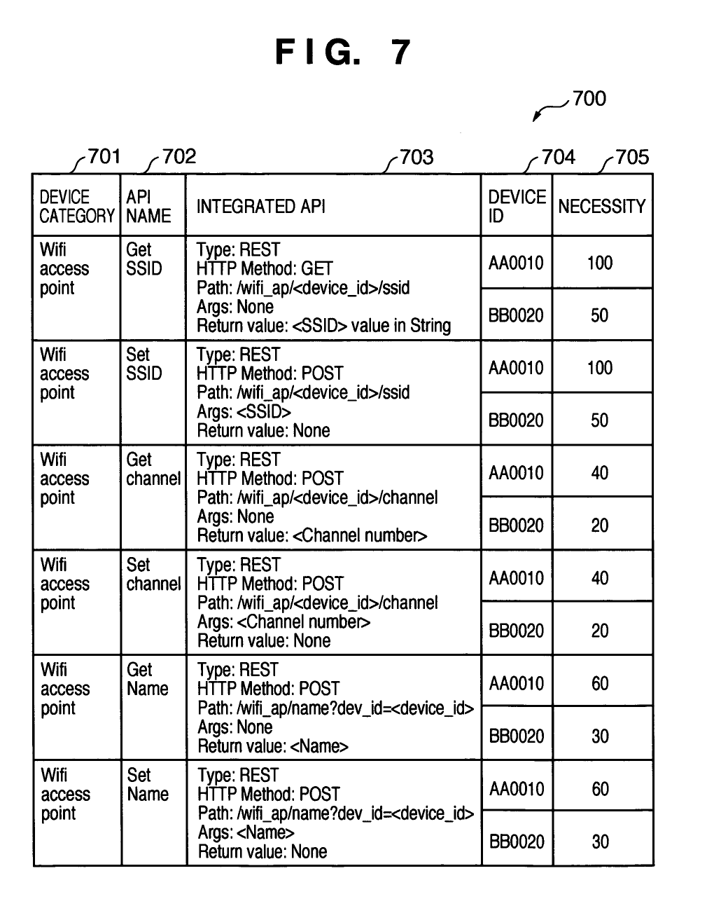

The integration unit 205 registers the integrated API in the required DSS list. FIG. 7 illustrates an exemplary required DSS list 700. Each entry of the required DSS list 700 describes a required DSS to be developed. The columns 701, 702 are the same as the columns 602, 603 in FIG. 6. The column “INTEGRATED API” 703 describes details of the integrated API. The columns 704, 705 will be described later. The first and fifth entries in the service description list 600 are integrated into the first entry in the required DSS list 700. It should be noted that the integration unit 205 replaces the “Path” property in the first entry with a default value. In this way, the integration unit 205 replaces changeable properties in integrated APIs with default values and then registers the integrated APIs in the required DSS lists 700. In step S305, the integration unit 205 notifies the generation unit 206 that the required DSS list 700 is updated.

In step S306, the generation unit 206 generates information about the necessity for development of a DSS implementing the integrated API. According to this embodiment, the generation unit 206 determines the necessity for each device type stored in the statistics database. The generation unit 206 registers every device type for each integrated API, as shown in FIG. 7. In this example, the statistics database includes two device types in the category “Wifi access point”, whose device IDs are “AA0010” and “BB0020”. The column “DEVICE ID” 704 describes a device ID of a device for which a DSS is required to be developed. Then, the generation unit 206 determines the necessity for each device ID. The generation unit 206 determines the necessity based on, for example, at least one of the statistics stored in the statistics database and the priority for the required API. The generation unit 206 sets larger value for the necessity when the integrated API has higher priority because the network operator would pay higher price for the DSS. In addition to or alternatively, the generation unit 206 sets larger value for the necessity when the number of device for a certain device ID is larger. For example, if the number of the devices whose ID is “AA0010” is twice of the number of the devices whose ID is “BB0020”, the generation unit 206 sets the necessities so that the value for the “AA0010” is twice of the value for the “BB0020”. The necessity value may correspond to an estimated payment for the development of the DSS. The generation unit 206 may set the necessities of DSSs which are already stored in the DSS repository, to zero. In step S307, the generation unit 206 notifies the presentation unit 210 that the required DSS list 700 is updated.

In step S308, the presentation unit 210 presents the developers 102 with the required DSS list 700 via the developer I/F 207. It should be noted that the required DSS list 700 does not show any information about the individual network operator. That is, each network operator can conceal its service descriptions and the number of devices for which the network operator provides services, from other network operators and the developers 102.

In step S309, the developer 102a develops a DSS with reference to the required DSS list 700. The developer 102a would develop a DSS with higher necessity. In step S310, the obtaining unit 209 obtains a developed DSS from the developer 102a via the developer I/F 207. In step S311, the obtaining unit 209 forwards the obtained DSS to the validation unit 208.

In step S312, the validation unit 208 verifies the obtained DSS. For example, the validation unit 208 checks whether the DSS includes a malicious code, using sandbox technique in Java. After checking the DSS, the validation unit 208 registers the DSS in the DSS repository. The validation unit 208 may not check the DSS against specific devices because it is up to network operators how to test the DSS before widely deploying the DSS. In step S313, the validation unit 208 notifies the presentation unit 210 that the DSS repository is updated.

In step S314, the presentation unit 210 presents the updated DSS repository to the network operators via the operator I/F 203. In step S315, the network operator A requests a DSS in the DSS repository in order to, for example, deliver the DSS to the gateway 105 or put its own Application Store. The FBS 100 may charge the network operator for the DSS.

In step S316, the operator I/F 203 notifies the integration unit 205 of which DSS is requested from which network operator A.

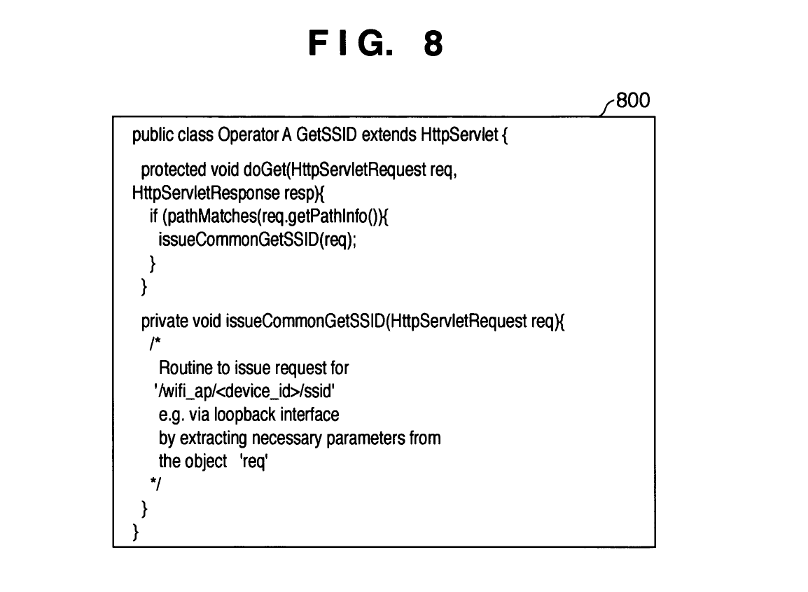

In step S317, the integration unit 205 creates an adaptation program. As described above, the API in the service description 500 and the API in the required DSS list 600 are different. That is, the developed DSS does not work without an adaptation program. For example, when the network operator A requests a DSS for the API whose name is “Get SSID”, the integration unit 205 refers the service description list 600 and finds the required API obtained from the network operator A. Then, the integration unit 205 creates an adaptation program 800 such as described in FIG. 8. The integration unit 205 may combine these programs so as to provide as a final deliverable program.

In step S318, the integration unit 205 notifies the presentation unit 210 that the adaptation program is created.

In step S319, the presentation unit 210 provides the requested DSS and the corresponding adaptation program with the network operator A via the operator I/F 203.

According to this embodiment, the developers can determine the necessity for a computer program required by the network operators while each network operator conceals requirements for the computer program. Each network operator can lower costs for obtaining a computer program. Each network operator does not have to share requirements with each other or co-develop a specification for a particular DSS together.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

1. An apparatus for intermediating a plurality of network operators and one or more developers, comprising:
an obtaining unit configured to obtain a requirement about a computer program required by each network operator;
an integration unit configured to integrate mutually-related requirements among the obtained requirements into one requirement;
a generation unit configured to generate information about the necessity for development of a computer program implementing the integrated requirement; and
a presentation unit configured to present the one or more developers with the integrated requirement and the information about the necessity.

2. The apparatus of claim 1, wherein the information about the necessity includes an estimated payment for the development of the computer program.

3. The apparatus of claim 1:
wherein each network operator is connected to a local network; and
wherein the computer program required by the network operator is a computer program used for a device in the local network.

4. The apparatus of claim 3, further comprising a collection unit configured to collect statistics of devices in the local network, wherein the information about the necessity is generated based on the statistics.

5. The apparatus of claim 4, wherein the statistics include the number of devices for which the computer program to be developed intends to be used.

6. The apparatus of claim 3, wherein the mutually-related requirements are requirements for the same operation for the device in the same category.

7. The apparatus of claim 6, wherein the operation for the device includes at least one of parameter handling, command execution and event detection.

8. The apparatus of claim 1:
wherein the presentation unit is further configured to present the plurality of network operators with patterns of requirements which are used by the network operator in order to describe a requirement; and
wherein the integration unit is further configured to integrate requirements described using the same pattern into one requirement.

9. The apparatus of claim 1:
wherein the obtaining unit further obtains the computer program developed by the one or more developers; and
wherein the presentation unit further presents the developed computer program to the plurality of network operators.

10. The apparatus of claim 9, wherein the integration unit is further configured to create a complementary computer program for adapting the developed computer program to the computer program required by the network operator.
